(19) United States
(12) Patent Application Publication
(10) Pub. No.: US 2018/0247310 A1
(43) Pub. Date: Aug. 30, 2018

(54) SYSTEM AND METHOD FOR VALIDATING A CASHLESS TRANSACTION

(71) Applicant: MASTERCARD INTERNATIONAL INCORPORATED, Purchase, NY (US)

(72) Inventor: ALAN GORENSTEIN, Fairfield, CT (US)

(21) Appl. No.: 15/444,622

(22) Filed: Feb. 28, 2017

(51) Int. Cl. G06Q 20/40; G06Q 20/10

(52) U.S. Cl. CPC G06Q 20/405; G06Q 20/40145; G06Q 20/10

(57) ABSTRACT

A system and method for validating a transaction between a consumer and a merchant after the transaction has been completed. An image of the consumer is captured in real-time as the transaction is occurring and associated with a transaction record for the transaction. Whether by a camera at the point of sale, or a “selfie” using a mobile device, a visual record is created of the person engaged in the transaction that may be used after the transaction is completed to determine if the transaction was entered into by the owner of the cashless transaction account (i.e., the cardholder).

### FIELD OF THE INVENTION

The present invention relates to an improved system and method for validating a transaction between a consumer and a merchant after the transaction has been completed.

### BACKGROUND OF THE INVENTION

Credit card issuers spend significant amounts of time and money responding to consumer disputes. A typical type of dispute is the consumer denying that he/she purchased an item that appears on his/her statement. In some cases, the dispute is legitimate, and the consumer did not, in fact, purchase the item. The mistake on the consumer's credit/debit card statement may be the result of an error by the issuer, or more likely, fraud. Other times the consumer did purchase the item but is disputing that fact to not pay for the item. There are consumers who may do this repeatedly, engaging in a pattern of fraud, and there are consumers who may do this once. In either case the issuer wants to ensure payment for the item is forthcoming to avoid the merchant and/or issuer having to take a loss.

In any case of a consumer initiated dispute, the issuer has little definitive proof to associate the consumer with the transaction other than use of the consumer's account number and possibly a consumer signature, the latter not even required to complete an e-commerce or mobile transaction. For each transaction, the issuer creates and stores a transaction record that contains certain details of the transaction, e.g., merchant ID, location, and category, merchandise ID, category, cost, consumer credit/debit card account number, and possibly a verification such as a signature. However, the transaction record does not provide objectively verifiable information that the consumer did, in fact, engage in the transaction and purchase the item(s) that is (are) the subject of the transaction record. It is typically a matter of honesty and trust—if a consumer maintains he/she did not engage in a transaction, there is little the issuer can do to contradict the consumer.

There exists a need in the art by which an issuer can more definitively determine a consumer did in fact engage in a transaction.

### SUMMARY OF THE INVENTION

The present invention is directed to a system and method for validating a transaction between a consumer and a merchant after the transaction has been completed. In accordance with embodiments of the present invention, a system and method provide an improved way for an issuer to validate cashless transactions after the transactions are completed. The present invention captures an image of the consumer in real-time as the transaction is occurring. Whether by a camera at the point of sale, or a “selfie” using a mobile device, or capturing a photo stored in social media that can be accessed via logging in to the social media account, the present invention creates a visual record of an aspect of the transaction and associates that visual record with the transaction record. The issuer can thereafter use the visual record, i.e., the captured image, in response to a consumer dispute to identify the person who engaged in the transaction.

An embodiment of the present invention is directed to a system for validating a transaction between a consumer and a merchant after the transaction is completed. An image of the consumer is captured by an image capture device during the transaction, the image is associated with a transaction record for the transaction, and the image and transaction record are stored in memory for access after completion of the transaction. The system comprises: a first database containing a plurality of database records, including a database record for the transaction record; a second database containing a plurality of database records, including a database record for the image; and a server having a processor and memory and in communication with the first database and the second database. The processor is operable by a program of instructions stored in the server memory, and the program of instructions, when executed by the processor, causes the processor to: access the transaction record in the database record for the transaction record; access the image in the database record for the image; access another image; determine if the another image is an image of the consumer; and validate the transaction if the another image is an image of the consumer.

An embodiment of the present invention is further directed to a system for validating a transaction between a consumer and a merchant after the transaction is completed, wherein the program of instructions, when executed by the processor, further causes the processor to access another image in the second database.

An embodiment of the present invention is further directed to a system for validating a transaction between a consumer and a merchant after the transaction is completed, wherein the program of instructions, when executed by the processor, further causes the processor to access another image in a publicly available source.

An embodiment of the present invention is further directed to a system for validating a transaction between a consumer and a merchant after the transaction is completed, wherein the first database and the second database comprise a single database.

An embodiment of the present invention is further directed to a system for validating a transaction between a consumer and a merchant after the transaction is completed, wherein the program of instructions, when executed by the processor, further causes the processor to: determine a probability of match score for the another image; display the another image if the probability of match score is the same as or greater than a predetermined value; and validate the transaction if the probability of match score is the same as or greater than a predetermined value.

Another embodiment of the present invention is directed to a method for validating a transaction between a consumer and a merchant after the transaction is completed. An image of the consumer is captured by an image capture device during the transaction, the image is associated with a transaction record for the transaction, and the transaction record is stored in a first database and the image being stored in a second database. The method comprises, after the transaction is completed, the steps of: accessing the transaction record; accessing the image; accessing another image; determining if the another image is an image of the consumer; and validating the transaction if the another image is an image of the consumer.

An embodiment of the present invention is further directed to a method for validating a transaction between a consumer and a merchant after the transaction is completed, further comprising the step of accessing another image in the second database.

An embodiment of the present invention is further directed to a method for validating a transaction between a consumer and a merchant after the transaction is completed, further comprising the step of accessing another image in a publicly available source.

An embodiment of the present invention is further directed to a method for validating a transaction between a consumer and a merchant after the transaction is completed, further comprising the steps of: determining a probability of match score for the another image; displaying the another image if the probability of match score is the same as or greater than a predetermined value; and validating the transaction if the probability of match score is the same as or greater than a predetermined value.

Another embodiment of the present invention is directed to a system for validating a transaction between a consumer and a merchant after the transaction is completed. An image of the consumer is captured by an image capture device during the transaction. The image is associated with a transaction record for the transaction and the image and transaction record are stored in memory for access after completion of the transaction. The system comprises: a first database containing a plurality of database records, including a database record for the transaction record; a second database containing a plurality of database records, including a database record for the image; and a server having a processor and memory and in communication with the first database and the second database. The processor is operable by a program of instructions stored in the server memory, wherein the program of instructions, when executed by the processor, causes the processor to: access the transaction record in the database record for the transaction record; access the image in the database record for the image; access a plurality of other images; determine a probability of match score for at least one of the plurality of other images; display the at least one of the plurality of other images if the probability of match score is the same as or greater than a predetermined value; and validate the transaction if the probability of match score is the same as or greater than a predetermined value.

An embodiment of the present invention is further directed to a system for validating a transaction between a consumer and a merchant after the transaction is completed, wherein the program of instructions, when executed by the processor, further causes the processor to access another image in the second database.

An embodiment of the present invention is further directed to a system for validating a transaction between a consumer and a merchant after the transaction is completed, wherein the program of instructions, when executed by the processor, further causes the processor to access another image in a publicly available source.

An embodiment of the present invention is further directed to a system for validating a transaction between a consumer and a merchant after the transaction is completed, wherein the first database and the second database comprise a single database.

Another embodiment of the present invention is directed to a method for validating a transaction between a consumer and a merchant after the transaction is completed. An image of the consumer is captured by an image capture device during the transaction. The image is associated with a transaction record for the transaction, the transaction record is stored in a first database, and the image is stored in a second database. The method comprises, after the transaction is completed, the steps of: accessing the transaction record; accessing the image; accessing a plurality of other images; determining a probability of match score for at least one of the plurality of other images; displaying the image if the probability of match score is the same as or greater than a predetermined value; and validating the transaction if the probability of match score is the same as or greater than a predetermined value.

An embodiment of the present invention is further directed to a method for validating a transaction between a consumer and a merchant after the transaction is completed, further comprising the step of accessing a plurality of others image in the second database.

An embodiment of the present invention is further directed to a method for validating a transaction between a consumer and a merchant after the transaction is completed, further comprising the step of accessing a plurality of other images in a publicly available source.

### DESCRIPTION OF THE DRAWINGS

Embodiments of the present invention will now be described with reference to the following figures, wherein:

FIG. 1 depicts a system for validating a transaction between a consumer and a merchant after the transaction has been completed, including certain devices and components configured in accordance with embodiments of the present invention;

FIG. 2 is a flow diagram of steps for capturing an image of a consumer during a transaction in accordance with embodiments of the present invention;

FIG. 3 is a flow diagram of steps for validating a transaction using an image of a consumer captured during the transaction in accordance with embodiments of the present invention;

FIG. 4 depicts an illustrative display screen viewable by an issuer's customer service representative in accordance with embodiments of the present invention; and

FIG. 5 is a block-diagram schematic of a server in accordance with embodiments of the present invention.

### DESCRIPTION OF EMBODIMENTS OF THE INVENTION

As used herein, the term “connectable” refers to various states of connection between electronic devices. For example, “connectable” refers to a physical connection between electronic devices, a wireless connection between electronic devices, a combination of a physical and wireless connection between electronic devices, a transient or episodic connection between electronic devices. As used herein the term “connectable” also refers to various states of connectivity between electronic devices such as, by way of non-limiting example, when electronic devices are not connected, when electronic devices are connecting, and when electronic devices are connected.

The present invention is directed to a system and method for validating a transaction between a consumer and a merchant after the transaction has been completed. In accordance with embodiments of the present invention, a system and method provide an improved way for an issuer to validate cashless transactions after the transactions are completed. The present invention captures an image of the consumer in real-time as the transaction is occurring. Whether by a camera at the point of sale, or a “selfie” using a mobile device, or social media site photo capture, the present invention creates a visual record of an aspect of the transaction and associates that visual record with the transaction record. The issuer can thereafter user the visual record, i.e., the captured image, in response to a consumer dispute to identify the person who engaged in the transaction.

All parties to the transaction benefit from the present invention because transactions are verifiable after-the-fact by evidence obtained in real-time during the transaction. No special hardware is required for merchants or consumers to implement the present invention, and the shopping experience for both the merchant and consumer is virtually the same. The only change is the additional step of capturing an image of the consumer during the transaction, but this is accomplished using standard hardware at the point of sale of via the consumer mobile electronic device or inexpensive installed digital cameras at the point of sale. The present invention captures an additional aspect of the cashless transaction at the time the transaction is being undertaken. The image of the consumer captured during the transaction and then associated with the transaction for later reference enables all parties to the transaction (e.g., consumer, merchant, issuer) to determine whether the person who engaged in the cashless transaction with the merchant was in fact the owner or an authorized user of the account. This ensures that merchants are paid for goods and services purchased and that consumers are not charged for goods and services they did not purchase.

Referring next to the drawings in detail, embodiments of the present invention will now be discussed. The present invention is directed to a system and method for validating a cashless transaction between a consumer 10 and a merchant 20 after the transaction has been completed. By capturing a picture of the consumer 10 in real-time during the transaction, associating that image with a transaction record for the transaction and storing the image and the transaction record, the present invention enables an issuer 30 of a cashless transaction card (e.g., credit card, debit card, gift card, etc.) to maintain an image of the person who entered into the transaction and determine at a time after the transaction if that person was the owner (i.e., cardholder) of the cashless transaction card and account. The issuer 30 may use the image and associated information to determine whether the consumer 10 was in fact the owner or an authorized user of the cashless transaction card and account. A merchant 20 has a merchant server 26 that is connectable over a network 100 to an issuer server 32 for electronic transactions entered into between the merchant 20 and a consumer 10. The consumer 10 may be physically present at the merchant location, or the consumer 10 may access the merchant goods/services remotely via a merchant website 28 using a consumer mobile electronic device 12 such as, by way of non-limiting example, smartphone, tablet, computer, etc. For transactions between the consumer 10 and the merchant 20 at the merchant location, the merchant uses a camera 24 proximate a point-of-sale terminal 22 to capture an image of the consumer 10 during the transaction. The captured image is transiently stored as an image file in memory of the point of sale terminal 22 or merchant server 26 in any now know or hereafter developed suitable format including, but not limited to JPG, TIF, GIF or PNG file. A high-quality image will best enable the issuer 30 to utilize the present invention to validate a transaction between a consumer and a merchant after the transaction is completed, and a TIF or PNG image file is known to provide the highest quality and may lead to better facial recognition matching probabilities. A merchant 30 may select the format for the image file based upon merchant-specific limitations or preferences such as point of sale device limitations, network connection and communication speed, etc.

Various information and data are communicated between the merchant 20 and issuer 30 during the transaction including, by way of illustration and not limitation, transaction authorization request and approvals or denials, transaction records and, upon implementation of the present invention, images. At a point during the transaction the merchant 20 will activate the camera 24 and take a picture of the consumer 10. The picture is transmitted by one or both of the point of sale terminal 22 and merchant server 26 over the network 100 to the issuer server 32, and stored in an image database 36 accessible by the issuer server 32. The image may be temporarily stored in one or both of the point of sale terminal 22 and merchant server 26 until the transaction is completed. If the consumer 10 is shopping remotely he/she will use a camera 14 of the consumer mobile electronic device 12 to capture an image during the transaction. That image is transmitted by the consumer mobile electronic device 12 to the merchant server 26, and over the network 100 to the issuer server 32 for storage in the image database 36.

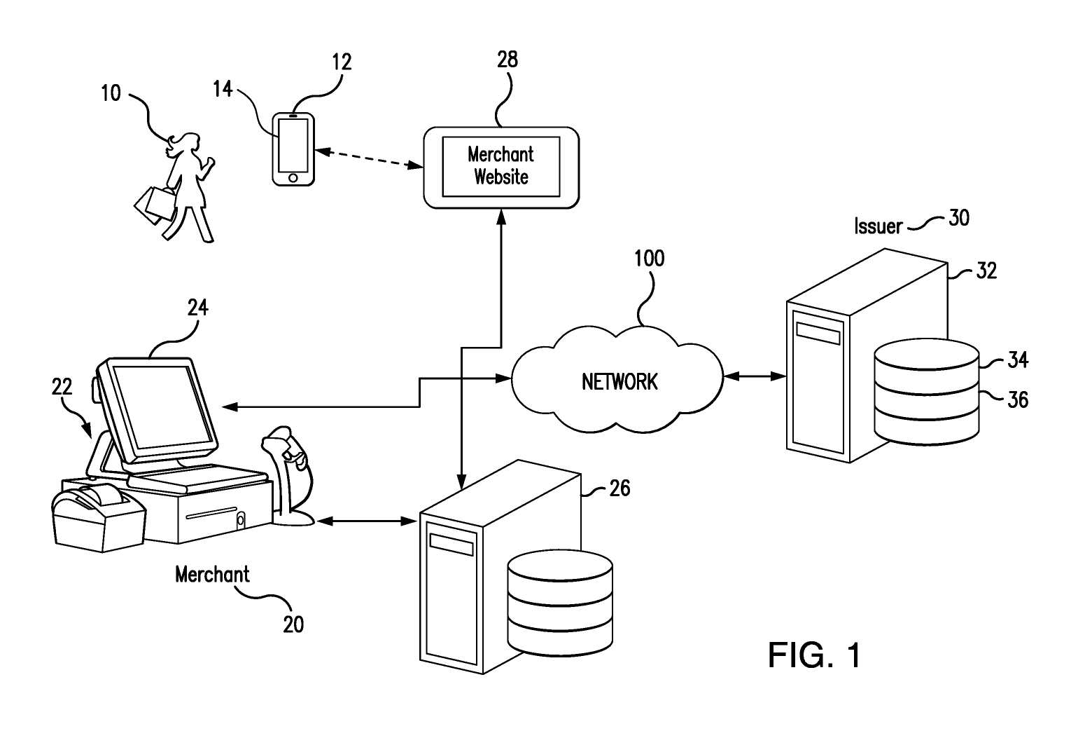

A transaction record is also created for the transaction that includes, by way of example and not limitation, the date, time, merchant name, merchant location, unique transaction ID, purchased item ID (SKU), price, discount (if applicable), final price, payment account identification number (e.g., credit card, debit card, gift card, etc.), amount paid, and other information about the transaction. The transaction record is transmitted by one or both of the point of sale terminal 22 and merchant server 26 over the network 100 to the issuer server 32 and stored in a transaction database 34. Although FIG. 1 depicts separate transaction and image databases 34, 36, a single database is also contemplated by, and within the scope and spirit of the present invention.

The transaction record and image may be transmitted as separate communications by the merchant 20 to the issuer 30, or they may be transmitted as a single communication, with an image file appended to a transaction record file, for example. In this way the issuer 30 builds a database of transaction records with associated images (either appended or cross-referenced) usable by the issuer 30 to validate transactions after the transactions are completed in accordance with embodiments of the present invention.

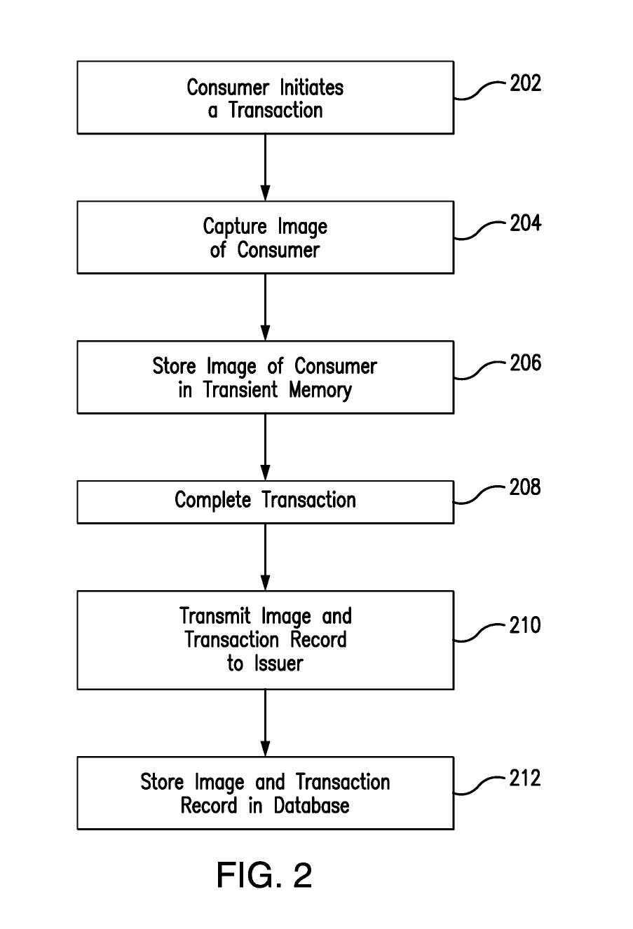

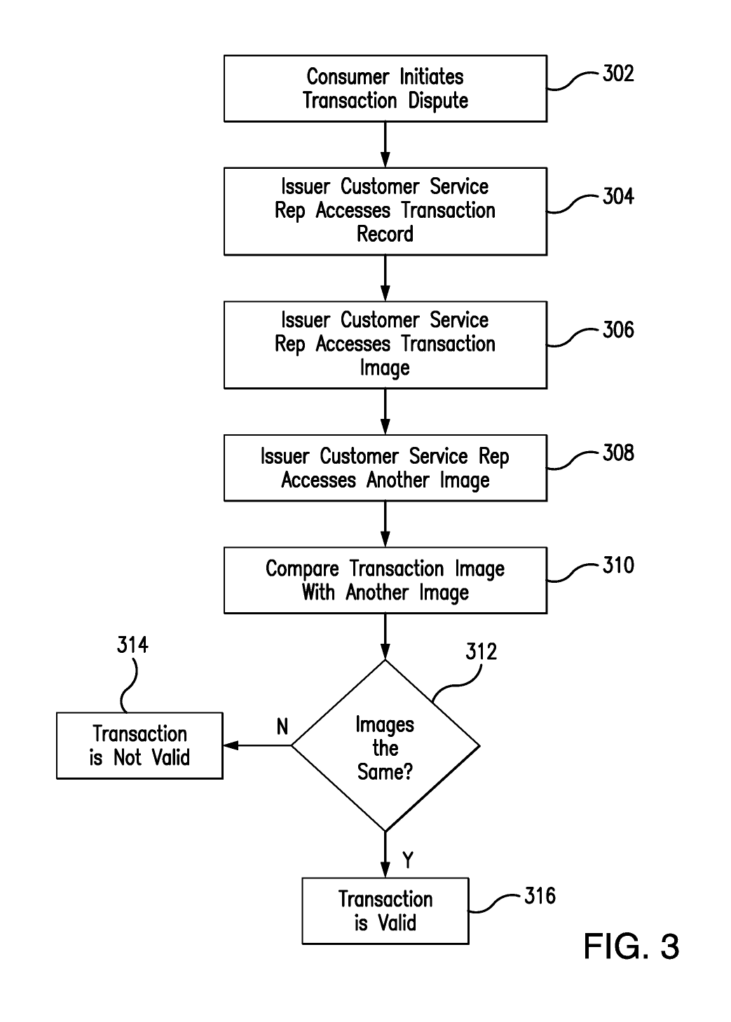

With reference next to FIGS. 2 and 3, the present invention will now be discussed in further detail. At 202 a consumer 10 initiates a transaction either by presenting his/her card or making a selection (e.g., “check-out”) on his/her mobile electronic device 12. If the consumer 10 is shopping at the merchant location, the merchant representative (i.e., the salesperson) will be prompted via the point of sale terminal 22 to take a picture of the consumer 10. This aspect of the present invention may be such that the transaction will not proceed until the image of the consumer 10 is captured. This aspect may also be activated only for transactions exceeding a predetermined amount, as set by either the merchant 20 or issuer 30. The salesperson will, at 204, active the camera 24 and capture an image of the consumer 10 that will be transiently stored in memory of the point of sale terminal 22 and/or merchant server 26 at 206. The consumer 10 and merchant 20 complete the transaction at 208, and the image and transaction record are transmitted as separate files or as a single file by the merchant server 26 to the issuer server 32 at 210, and, at 212, stored in memory that may be one or both of the transaction database 34 and the image database 36.

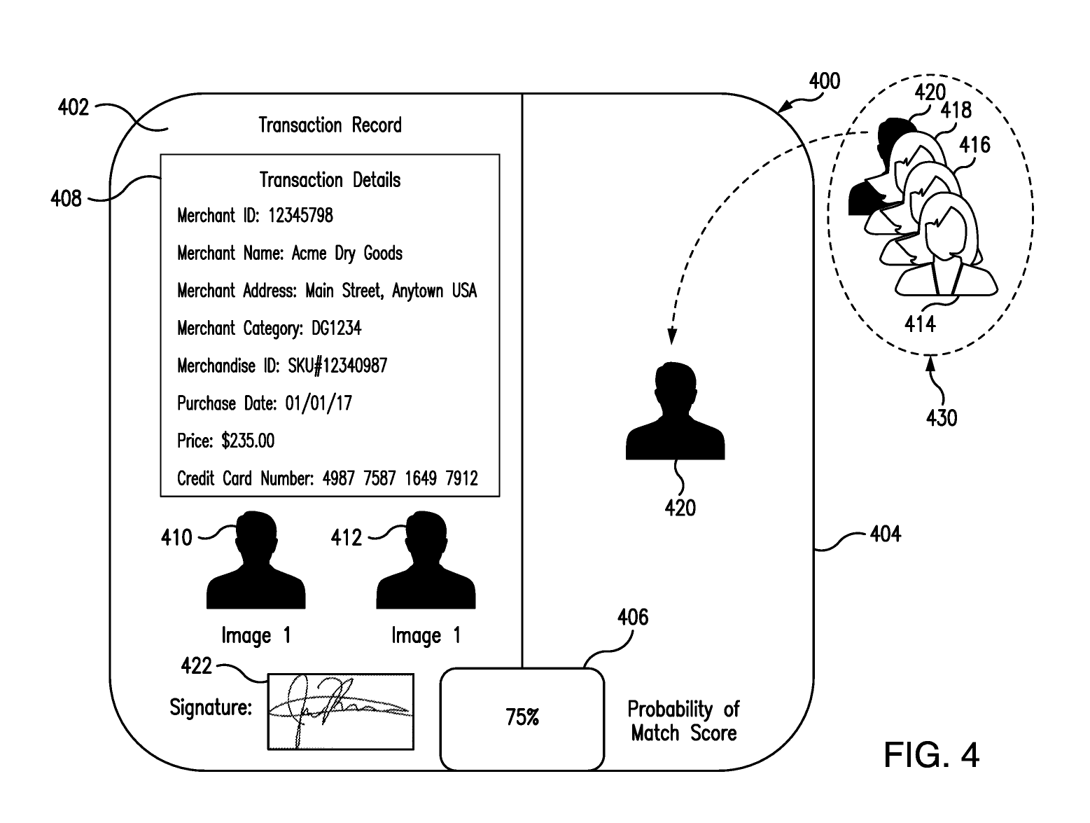

With reference next to FIGS. 3 and 4, further aspects of the present invention will now be discussed. As noted, it is not uncommon for a consumer 10 to dispute a transaction, typically asserting that the consumer 10 did not engage in a particular transaction with a particular merchant 20. The consumer 10 can initiate a dispute at 302 by contacting the issuer 30 by telephone, for example. The issuer customer service representative will access the transaction record for the disputed transaction, at 304, with the transaction record and other information (discussed below) made available to the customer service representative as a display 400 on a screen, terminal or the like, as depicted in FIG. 4. The display 400 may have a transaction record part 402, an image part 404 and a probability of match score part 406. The transaction part 402 may include transaction details 408 such as, by way of non-limiting example, merchant ID, location, and category, merchandise ID, category, and cost, consumer credit/debit card account number, and possibly a verification such as a signature. The transaction part 402 may also include at least one image 410 of the consumer 10 taken by the merchant 20 or by the consumer 10 in real-time during the transaction, thus providing the issuer 30 with access to an image of the customer 10, at 306 of FIG. 3. A second image 412 or a plurality of images of the consumer taken in real-time during the transaction may also be displayed in the transaction record part 402.

To determine whether the image captured during the transaction is in fact an image of the consumer 10, the present invention enables the issuer customer service representative to access one or more other images 414, 416, 418, 420, at 308, from a variety of image locations 430. The one or more other images may be images associated with other transaction records for the same account number, ostensibly for the same consumer, or they may be images obtained from other publicly accessible sources such as social media accounts associated with the consumer. For example, the present invention may access an image of the consumer 10 stored in the image database 36 for a previous transaction. Alternatively, the present invention may search social media sites for images of the consumer 10, using the consumer's name as one search criteria. In one embodiment, the images accessed will be displayed in the image part 404, and the customer service representative will determine whether the accessed image is an image of the consumer 10, and whether the transaction is valid. In another embodiment, the present invention will calculate a probability of match score for any image accessed to determine the likelihood that the image is in fact an image of the consumer 10, in which case the image 420 is displayed in the image part 404 of the display 400. Images may be displayed in the image part 404 based upon their respective probability of match scores, for example, in order from highest probability of match to lowest. Alternatively, the present invention may display only images have a probability of match score the same as or greater than a predetermined value, with that value being defined by the issuer 30. At 310, the issuer customer service representative can attempt to determine by simple visual comparison whether the image 410, 412 associated with the transaction record is the same as one or more other images 414, 416, 418, 420. Alternatively, embodiments of the present invention assist with that determination by generating and displaying in 406 a probability of match score between at least one image 410, 412 associated with the transaction, and at least one another image 414, 416, 418, 420. If the probability of match score is the same as or greater than a predetermined value, the image 420 is displayed in the image part 404 and the transaction is valid.

Every face has unique aspects and combinations of aspects. Depending on the mapping method used, approximately 100 specific points of identification (eye distance, skin texture at varying points, cheek bone geometry, etc.) can be estimated. Each of these distinct points can be expressed mathematically. Using algorithms to evaluate these unique points can be accomplished through commercially available products. These products can also state the similarity between pictures based on these mathematical models and the probability of a matched subject (individual).

The following further explanation of a facial recognition process is provided as an exemplary, non-limiting example of one of a number of ways this can be accomplished, in accordance with embodiments of the present invention. It should be understood that he following explanation does not limit or otherwise define boundaries of the present invention, which are defined by the claims. Facial recognition can be accomplished in four steps: 1) understanding the position of the subject face relative to the camera; 2) normalizing for the positioning effect; 3) collecting either “face data” (mapping facial features and/or textures), or “pixel data” (mapping pixel position to describe the composition of the face); and 4) feeding the features into an algorithm which is then compared to other faces. A percentage match between the subject face and another face is then calculable because each of the subject face and another face have been converted to numerical representations based upon the facial recognition process.

Step 1 can be completed utilizing the Viola & Jones face detection algorithm (as one example). Step 2 involves standardizing all variables for position, photo treatments, exposure, etc. (e.g. using histogram equalization). Step 3 can be accomplished using known methods such as, for example, “Eigenfaces.” The concept here is that pictures can be approximated as a linear combination of base images (found through principal component analysis using a set of prior related or unrelated images). These factors are then used as features. This approach is used for distinct parts of the face and where these parts can be combined into a whole face as well.

In step 4, the resulting “numeric set” for the images of the subject face and of the another face(s) are mathematically evaluated for their percent match with each other. It is a percent calculation for mathematically equivalency. This is what the algorithms (written in, for example, R, Python or SAS) support. A typically algorithm is the support vector machine (SVM). Other choices include artificial neural networks or k-nearest neighbors.

If it is determined, at 312, that the images are the same, the transaction is deemed to be valid, at 316, and the consumer dispute is dismissed. If, on the other hand, it is determined that the images are not the same, the transaction is considered to be invalid, and the consumer 10 will not be responsible for paying for the disputed items in the transaction record.

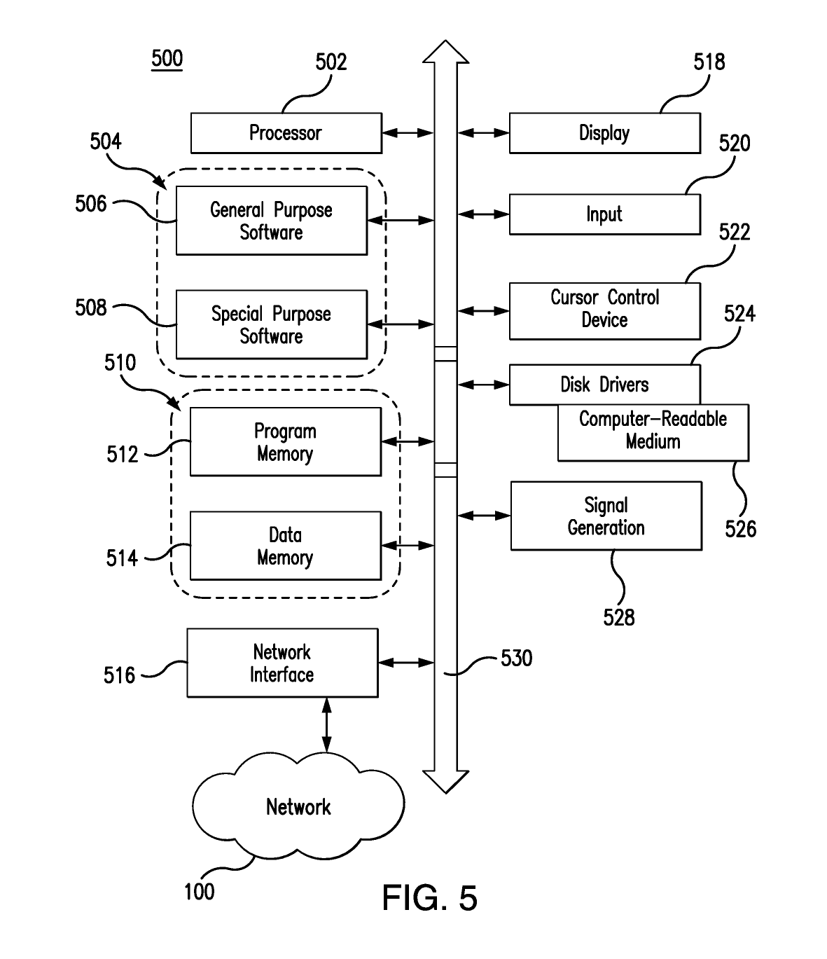

With continued reference to FIG. 1, and additional reference to FIG. 5, a server 500 in accordance with embodiments of the present invention will now be discussed in more detail. The server 500 may be a general purpose computing device having a plurality of devices and components operably connected over a bus 460. The server 500 has one or more processors 402 or central processing units (“CPU”). Although the server 500 of the present invention is discussed as having a single processor 502, a server having multiple processor, either separate or integrated in a multi-core processor, for example, are also contemplated by and within the scope and spirit of the present invention. Reference to processor in the singular herein shall be interpreted to include any variation and number of processors. The processor 502 is operable by at least one program of instructions 504 comprising general purpose software 506 to carry out functions that enable the server 500 to interface with its various hardware components (discussed further below), and to interface and communicate with other devices. The processor 502 of the present invention is also operable by at least one program of instructions 504 comprising special purpose software 508 to carry out aspects of the present invention. The general purpose software 506 and special purpose software 508 may be stored on the server 500 in memory 510 that may comprise program memory 512 and data memory 514, or it may be stored on one or more disk drives 524 comprised of a computer-readable medium 526, or it may be stored in/on any combination of the foregoing. As used herein, the term “memory” is intended to include all currently known or hereafter developed types of permanent or temporary storage devices or components in a computing device. Exemplary memory types include, by way of illustration and not limitation, Random Access Memory (RAM)—further including Dynamic RAM (DRAM), Static RAM (SRAM), and Direct Rambus DRAM (DRDRAM), Read Only Memory (ROM)—further including Programmable ROM (PROM), erasable PROM (EPROM), and Electrically EPROM (EEPROM), cache memory, hard drives and flash memory.

The server 500 further includes a display 518, input device(s) 520 (e.g., a keyboard), cursor control device(s) 522 (e.g., a mouse), signal generation device(s) 528 (e.g., a speaker or remote control), and network interface device(s) 516 that enable the server 500 to selectively connect to and with a network 100 and send or receive voice, video or data, and to communicate over the network 100 as controlled by the program of instructions 504.

The memory 510 and disk drives 524 each comprise computer-readable medium 526 that may each include a single medium or multiple media (e.g., a centralized or distributed database, and/or associated caches and servers) that store the one or more programs of instructions 504. As used herein, the term “computer-readable medium” means and includes, but is not limited to, solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives that is considered a distribution medium equivalent to a tangible storage medium. Accordingly, the embodiment is considered to include anyone or more of a tangible computer-readable medium or a tangible distribution medium, as listed herein and including art-recognized equivalents and successor media, in which the software implementations herein are stored. The term “computer-readable medium” also means and includes any medium that is capable of storing, encoding, or carrying a set of instructions in the general purpose software 506 and in the special purpose software 508.

Although the present specification may describe components and functions implemented in the embodiments with reference to particular standards and protocols, the disclosed embodiments are not limited to such standards and protocols.

In accordance with various embodiments, the present invention may be implemented as one or more software programs running on one or more computing devices and one or more computer processors. Dedicated hardware implementations including, but not limited to, application specific integrated circuits, programmable logic arrays and other hardware devices can likewise be constructed to implement the present invention. Furthermore, alternative software implementations including, but not limited to, distributed processing or component/object distributed processing, parallel processing, or virtual machine processing can also be constructed to implement the present invention.

Modifications to embodiments of the present invention are possible without departing from the scope of the invention as defined by the accompanying claims. Expressions such as “including,” “comprising,” “incorporating,” “consisting of,” “have,” “is,” used to describe and claim the present invention are intended to be construed in a non-exclusive manner, namely allowing for articles, components or elements not explicitly described herein also to be present. Reference to the singular is to be construed to relate to the plural, where applicable.

Although specific example embodiments have been described, it will be evident that various modifications and changes may be made to these embodiments without departing from the broader scope of the inventive subject matter described herein. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A system for validating a transaction between a consumer and a merchant after the transaction is completed, an image of the consumer being captured by an image capture device during the transaction, the image being associated with a transaction record for the transaction and the image and transaction record being stored in memory for access after completion of the transaction, the system comprising:
a first database containing a plurality of database records, including a database record for the transaction record;
a second database containing a plurality of database records, including a database record for the image; and
a server having a processor and memory and in communication with the first database and the second database, the processor being operable by a program of instructions stored in the server memory, wherein the program of instructions, when executed by the processor, after the transaction is completed, causes the processor to:
access the transaction record in the database record for the transaction record;
access the image in the database record for the image;
access another image;
determine if the another image is an image of the consumer; and
validate the transaction if the another image is an image of the consumer.

2. A system as recited by claim 1, wherein the program of instructions, when executed by the processor, further causes the processor to access another image in the second database.

3. A system as recited by claim 1, wherein the program of instructions, when executed by the processor, further causes the processor to access another image in a publicly available source.

4. A system as recited by claim 1, wherein the first database and the second database comprise a single database.

5. A system as recited by claim 1, wherein the program of instructions, when executed by the processor, further causes the processor to:
determine a probability of match score for the another image;
display the another image if the probability of match score is the same as or greater than a predetermined value; and
validate the transaction if the probability of match score is the same as or greater than a predetermined value.

6. A method for validating a transaction between a consumer and a merchant after the transaction is completed, an image of the consumer being captured by an image capture device during the transaction, the image being associated with a transaction record for the transaction and the transaction record being stored in a first database and the image being stored in a second database, the method comprising, after the transaction is completed, the steps of:
accessing the transaction record;
accessing the image;
accessing another image;
determining if the another image is an image of the consumer; and
validating the transaction if the another image is an image of the consumer.

7. A method as recited by claim 6, further comprising the step of accessing another image in the second database.

8. A method as recited by claim 6, further comprising the step of accessing another image in a publicly available source.

9. A method as recited by claim 6, further comprising the steps of:
determining a probability of match score for the another image;
displaying the another image if the probability of match score is the same as or greater than a predetermined value; and
validating the transaction if the probability of match score is the same as or greater than a predetermined value.

10. A system for validating a transaction between a consumer and a merchant after the transaction is completed, an image of the consumer being captured by an image capture device during the transaction, the image being associated with a transaction record for the transaction and the image and transaction record being stored in memory for access after completion of the transaction, the system comprising:
a first database containing a plurality of database records, including a database record for the transaction record;
a second database containing a plurality of database records, including a database record for the image; and
a server having a processor and memory and in communication with the first database and the second database, the processor being operable by a program of instructions stored in the server memory, wherein the program of instructions, when executed by the processor, after the transaction is completed, causes the processor to:
access the transaction record in the database record for the transaction record;
access the image in the database record for the image;
access a plurality of other images;
determine a probability of match score for at least one of the plurality of other images;
display the at least one of the plurality of other images if the probability of match score is the same as or greater than a predetermined value; and
validate the transaction if the probability of match score is the same as or greater than a predetermined value.

11. A system as recited by claim 10, wherein the program of instructions, when executed by the processor, further causes the processor to access another image in the second database.

12. A system as recited by claim 10, wherein the program of instructions, when executed by the processor, further causes the processor to access another image in a publicly available source.

13. A system as recited by claim 10, wherein the first database and the second database comprise a single database.

14. A method for validating a transaction between a consumer and a merchant after the transaction is completed, an image of the consumer being captured by an image capture device during the transaction, the image being associated with a transaction record for the transaction and the transaction record being stored in a first database and the image being stored in a second database, the method comprising, after the transaction is completed, the steps of:
accessing the transaction record;
accessing the image;
accessing a plurality of other images;
determining a probability of match score for at least one of the plurality of other images;
displaying the image if the probability of match score is the same as or greater than a predetermined value; and
validating the transaction if the probability of match score is the same as or greater than a predetermined value.

15. A method as recited by claim 14, further comprising the step of accessing a plurality of others image in the second database.

16. A method as recited by claim 14, further comprising the step of accessing a plurality of other images in a publicly available source.
